(19) United States
(12) Patent Application Publication
(10) Pub. No.: US 2025/0191204 A1
(43) Pub. Date: Jun. 12, 2025

(54) JOINT TRACKING AND SHAPE ESTIMATION

(71) Applicant: QUALCOMM Incorporated, San Diego, CA (US)

(72) Inventor: Andreas EIDEHALL, LINKÖPING (SE)

(21) Appl. No.: 18/534,189

(22) Filed: Dec. 8, 2023

(51) Int. Cl. G06T 7/50; G06T 7/20; G06V 10/44; G06V 10/74

(52) U.S. Cl. CPC G06T 7/50; G06T 7/20; G06V 10/44; G06V 10/761

(57) ABSTRACT

Techniques and systems are provided for shape estimation. For instance, a process can include: detecting first features of an object in a first frame of an environment, the environment including the object; determining a first set of three-dimensional (3D) points for the first frame based on the detected first features and first distance information obtained for the object; detecting second features of the object in a second frame of the environment; determining a second set of 3D points for the second frame based on the detected second features and second distance information obtained for the object; combining the first set of 3D points and the second set of 3D points to generate a combined set of 3D points; and estimating a shape of the object based on the combined set of 3D points.

### FIELD

The present disclosure generally relates to object tracking and estimation. For example, aspects of the present disclosure are related to systems and techniques for joint tracking and shape estimation of objects.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle.

Sensor data, such as frames (e.g., images) captured from one or more sensors, such as camera(s), radar, lidar, etc., may be gathered, transformed, and analyzed to detect objects (e.g., targets). Detected objects may be compared to known objects to help determine what object is being tracked. Generally, ADAS systems attempt to detect and identify substantially all objects in an environment surrounding the vehicle to help avoid potential collisions. However, objects in the environment may not correspond to known classes. For example, a branch, rock, mattress, ladder, etc. may have fallen into a path of the vehicle, or an unusually looking vehicle, such as a truck carrying industrial equipment may be on the road. As objects that do not fall into known classes, by definition, are unknown, it may be difficult to train an object detector to identify such objects for tracking. Techniques for general object detection and tracking may be useful for identifying and tracking objects that may not otherwise fit in a defined classification.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for shape estimation is provided. The apparatus includes: at least one memory; and at least one processor coupled to the at least one memory. The at least one processor is configured to: detect first features of an object in a first frame of an environment, the environment including the object; determine a first set of three-dimensional (3D) points for the first frame based on the detected first features and first distance information obtained for the object; detect second features of the object in a second frame of the environment; determine a second set of 3D points for the second frame based on the detected second features and second distance information obtained for the object; combine the first set of 3D points and the second set of 3D points to generate a combined set of 3D points; and estimate a shape of the object based on the combined set of 3D points.

As another example, a method for shape estimation is provided. The method includes shape estimation, comprising: detecting first features of an object in a first frame of an environment, the environment including the object; determining a first set of three-dimensional (3D) points for the first frame based on the detected first features and first distance information obtained for the object; detecting second features of the object in a second frame of the environment; determining a second set of 3D points for the second frame based on the detected second features and second distance information obtained for the object; combining the first set of 3D points and the second set of 3D points to generate a combined set of 3D points; and estimating a shape of the object based on the combined set of 3D points.

In another example, a non-transitory computer-readable medium having stored thereon instructions is provided. The instructions, when executed by at least one processor, cause the at least one processor to: detect first features of an object in a first frame of an environment, the environment including the object; determine a first set of three-dimensional (3D) points for the first frame based on the detected first features and first distance information obtained for the object; detect second features of the object in a second frame of the environment; determine a second set of 3D points for the second frame based on the detected second features and second distance information obtained for the object; combine the first set of 3D points and the second set of 3D points to generate a combined set of 3D points; and estimate a shape of the object based on the combined set of 3D points.

As another example, an apparatus for shape estimation is provided. The apparatus includes: means for detecting first features of an object in a first frame of an environment, the environment including the object; means for determining a first set of three-dimensional (3D) points for the first frame based on the detected first features and first distance information obtained for the object; means for detecting second features of the object in a second frame of the environment; means for determining a second set of 3D points for the second frame based on the detected second features and second distance information obtained for the object; means for combining the first set of 3D points and the second set of 3D points to generate a combined set of 3D points; and means for estimating a shape of the object based on the combined set of 3D points.

In some aspects, one or more of the apparatuses described herein is, is part of, and/or includes a vehicle or a computing device or component of a vehicle (e.g., an autonomous vehicle), a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus(es) includes a camera or multiple cameras for capturing one or more images. In some aspects, the apparatus(es) further includes a display for displaying one or more images, notifications, and/or other displayable data. In some aspects, the apparatus(es) can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIGS. 1A and 1B are block diagrams illustrating a vehicle suitable for implementing various techniques described herein, in accordance with aspects of the present disclosure;

FIG. 1C is a block diagram illustrating components of a vehicle suitable for implementing various techniques described herein, in accordance with aspects of the present disclosure;

FIG. 1D illustrates an example implementation of a system-on-a-chip (SOC), in accordance with some examples;

FIG. 2A is a component block diagram illustrating components of an example vehicle management system, in accordance with aspects of the present disclosure;

FIG. 2B is a component block diagram illustrating components of another example vehicle management system, in accordance with aspects of the present disclosure;

FIG. 3 illustrates an example segmentation process, in accordance with aspects of the present disclosure;

FIG. 4 illustrates an example joint tracking and shape estimation technique, in accordance with aspects of the present disclosure;

FIG. 5 is a flow diagram illustrating a process for object detection, in accordance with aspects of the present disclosure;

FIG. 6 illustrates an example computing device architecture of an example computing device which can implement techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Object detection may be used to identify objects. The identified objects may be used to determine where a tracking object is located relative to the identified objects. A tracking object may be understood to refer to any system or device capable of precisely locating itself in an environment and locating other objects in the environment. An example of a tracking object is a vehicle (referred to as an ego vehicle). Examples will be described herein using an ego vehicle as an example of a tracking object. However, other tracking objects can perform techniques described herein, such as robotic devices (e.g., an automated vacuum cleaner, an industrial robotic device, etc.), extended reality (XR) devices (e.g., a virtual reality (VR) device, an augmented reality (AR) device, and/or a mixed reality (MR) device), and/or other devices.

As noted previously, one or more sensors (e.g., image sensors, such as a camera, range sensors such as radar and/or light detection and ranging (LIDAR) sensors, etc.) of an ego vehicle may be used to obtain information about an environment in which the ego vehicle is located. A processing system of the ego vehicle may be used to process the information for one or more operations, such as localization, route planning, navigation, collision avoidance, among others. For example, in some cases, the sensor data may be obtained from the one or more sensor (e.g., one or more frames (e.g., images) captured from one or more cameras, depth information captured or determined by one or more frames from radar and/or LIDAR sensors, etc.), transformed, and analyzed to detect objects.

Generally, system that can move through an uncontrolled environment, such as autonomous vehicles or semi-autonomous vehicles, may encounter objects that may not belong to known classes of objects. As an example, a vehicle may encounter unusual objects that have fallen into its path, such as branches, rocks, tire treads, etc., or unusual objects with an unusual appearance, such as toppled garbage bins, trucks with unusual cargos, etc. In some cases, a sensor of the vehicle may detect such unusual objects, such as via a camera sensor, radar, and/or LIDAR, but may not be able to reliably identify the unusual object.

Systems, apparatuses, electronic devices, methods (also referred to as processes), and computer-readable media (collectively referred to herein as “systems and techniques”) are described herein for object tracking and shape estimation. In some aspects, a frame representing an environment may be obtained, for example, using a camera(s), lidar, radar, or other sensing device. The frame may be processed, for example, by a segmentation process to detect features and/or pixels (e.g., points) associated with an object in the frame. Distance information for the points of the object may also be obtained. Points may be accumulated (combined) over a number of frames (e.g., images, lidar/radar scans, etc.). Once a sufficient number of frames have been processed to accumulate points (or a sufficient number of points obtained for an object), the accumulated points may be processed to estimate a shape of the object. In some cases, outlier points may be rejected. For example, a threshold number/percentage of points furthest from a neighboring point for an object may be removed. In some cases, motion of the accumulated points may be determined, and the shape of the object may be determined based on the motion. For example, where a group of accumulated points are moving more than a threshold speed, the group of points for an object may be assumed to be a vehicle and a rectangular shape may be associated with the object. As another example, where group of accumulated points are moving more less a threshold speed, a polygonal shape based on the location of points of the group of points, may be used as the shape of the object.

The systems and techniques describe herein can be used to improve the object detection for objects that may be difficult to classify for various applications and systems, including autonomous driving, XR systems, robotics, scene understanding, among others.

Various aspects of the application will be described with respect to the figures.

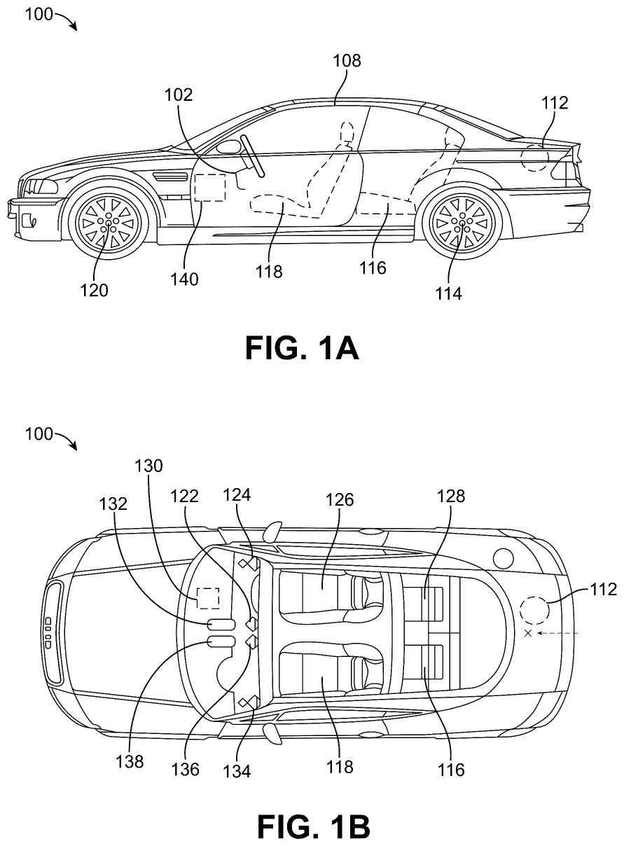

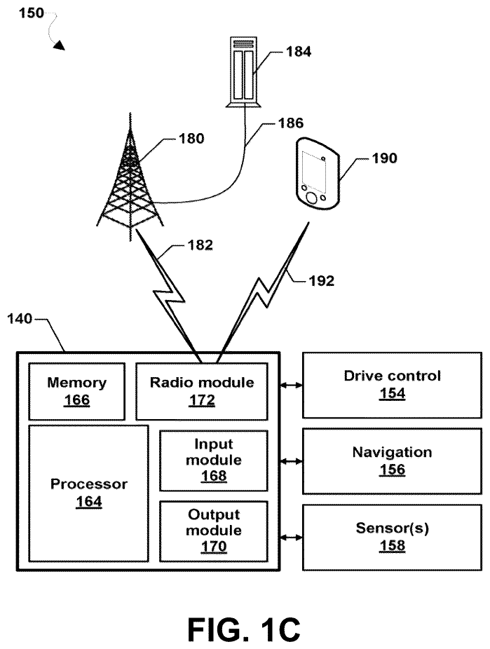

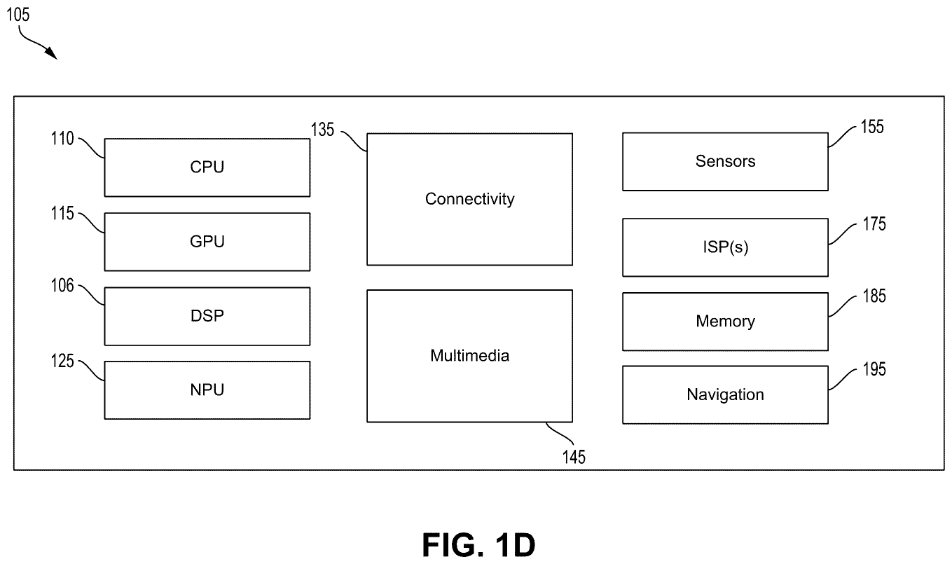

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various aspects using information received from various sensors, particularly the cameras 122, 136, radar 132, and LIDAR 138. In some aspects, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various aspects.

FIG. 1C is a component block diagram illustrating a system 150 of components and support systems suitable for implementing various aspects. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various aspects. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some aspects, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various aspects, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described and may be configured to provide a variety of data to the processor 164 and/or the navigation components 156. For example, the control unit 140 may aggregate and/or process data from the sensors 158 to produce information the navigation components 156 may use for localization. As a more specific example, the control unit 140 may process images from multiple camera sensors to generate a single semantically segmented image for the navigation components 156. As another example, the control unit 140 may generate a frame of fused point clouds from LIDAR and radar data for the navigation components 156.

While the control unit 140 is described as including separate components, in some aspects some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various aspects when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image sign 10 processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

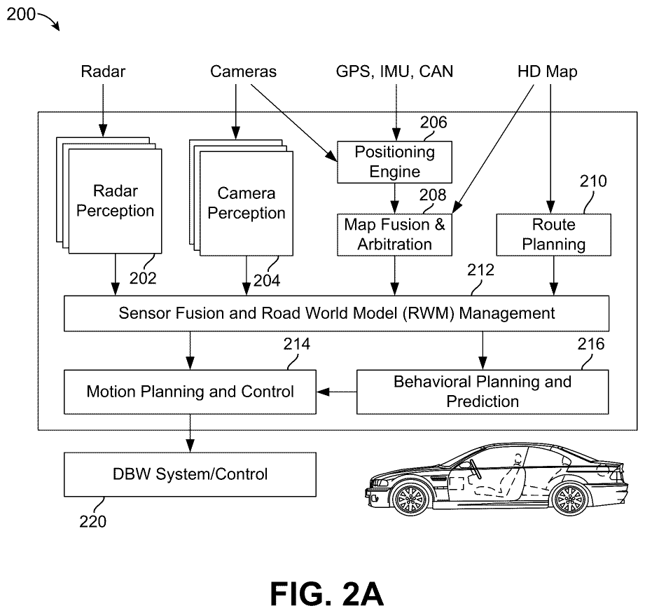

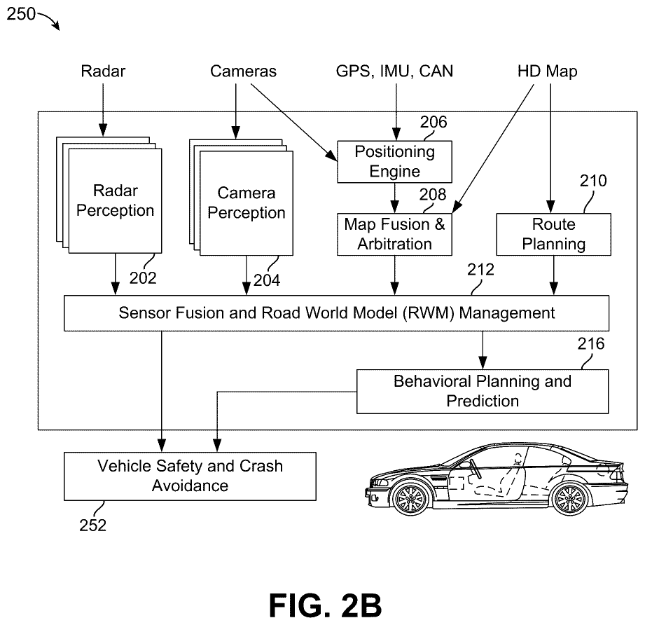

FIG. 2A illustrates an example of vehicle applications, subsystems, computational elements, or units within a vehicle management system 200, which may be utilized within a vehicle, such as vehicle 100 of FIG. 1A. With reference to FIGS. 1A-2A, in some aspects, the various vehicle applications, computational elements, or units within vehicle management system 200 may be implemented within a system of interconnected computing devices (i.e., subsystems), that communicate data and commands to each other. In other aspects, the vehicle management system 200 may be implemented as a plurality of vehicle applications executing within a single computing device, such as separate threads, processes, algorithms, or computational elements. However, the use of the term vehicle applications in describing various aspects are not intended to imply or require that the corresponding functionality is implemented within a single autonomous (or semi-autonomous) vehicle management system computing device, although that is a potential implementation aspect. Rather the use of the term vehicle applications is intended to encompass subsystems with independent processors, computational elements (e.g., threads, algorithms, subroutines, etc.) running in one or more computing devices, and combinations of subsystems and computational elements.

In various aspects, the vehicle applications executing in a vehicle management system 200 may include (but is not limited to) a radar perception vehicle application 202, a camera perception vehicle application 204, a positioning engine vehicle application 206, a map fusion and arbitration vehicle application 208, a route vehicle planning application 210, sensor fusion and road world model (RWM) management vehicle application 212, motion planning and control vehicle application 214, and behavioral planning and prediction vehicle application 216. The vehicle applications 202-216 are merely examples of some vehicle applications in one example configuration of the vehicle management system 200. In other configurations consistent with various aspects, other vehicle applications may be included, such as additional vehicle applications for other perception sensors (e.g., LIDAR perception layer, etc.), additional vehicle applications for planning and/or control, additional vehicle applications for modeling, etc., and/or certain of the vehicle applications 202-216 may be excluded from the vehicle management system 200. Each of the vehicle applications 202-216 may exchange data, computational results and commands.

The vehicle management system 200 may receive and process data from sensors (e.g., radar, LIDAR, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system 200 may output vehicle control commands or signals to the drive by wire (DBW) system/control unit 220, which is a system, subsystem or computing device that interfaces directly with vehicle steering, throttle and brake controls. The configuration of the vehicle management system 200 and DBW system/control unit 220 illustrated in FIG. 2A is merely an example configuration and other configurations of a vehicle management system and other vehicle components may be used in the various aspects. As an example, the configuration of the vehicle management system 200 and DBW system/control unit 220 illustrated in FIG. 2A may be used in a vehicle configured for autonomous or semi-autonomous operation while a different configuration may be used in a non-autonomous vehicle.

The radar perception vehicle application 202 may receive data from one or more detection and ranging sensors, such as radar (e.g., 132) and/or LIDAR (e.g., 138), and process the data to recognize and determine locations of other vehicles and objects within a vicinity of the vehicle 100. The radar perception vehicle application 202 may include use of neural network processing and artificial intelligence methods to recognize objects and vehicles, and pass such information on to the sensor fusion and RWM management vehicle application 212.

The camera perception vehicle application 204 may receive data from one or more cameras, such as cameras (e.g., 122, 136), and process the data to recognize and determine locations of other vehicles and objects within a vicinity of the vehicle 100. The camera perception vehicle application 204 may include use of neural network processing and artificial intelligence methods to recognize objects and vehicles and pass such information on to the sensor fusion and RWM management vehicle application 212.

The positioning engine vehicle application 206 may receive data from various sensors and process the data to determine a position of the vehicle 100. The various sensors may include, but is not limited to, GPS sensor, an IMU, and/or other sensors connected via a CAN bus. The positioning engine vehicle application 206 may also utilize inputs from one or more cameras, such as cameras (e.g., 122, 136) and/or any other available sensor, such as radars, LIDARs, etc.

The map fusion and arbitration vehicle application 208 may access data within a high-definition (HD) map database and receive output received from the positioning engine vehicle application 206 and process the data to further determine the position of the vehicle 100 within the map, such as location within a lane of traffic, position within a street map, etc., using localization. The HD map database may be stored in a memory (e.g., memory 166). For example, the map fusion and arbitration vehicle application 208 may convert latitude and longitude information from GPS into locations within a surface map of roads contained in the HD map database. GPS position fixes include errors, so the map fusion and arbitration vehicle application 208 may function to determine a best guess location of the vehicle 100 within a roadway based upon an arbitration between the GPS coordinates and the HD map data. For example, while GPS coordinates May place the vehicle 100 near the middle of a two-lane road in the HD map, the map fusion and arbitration vehicle application 208 may determine from the direction of travel that the vehicle 100 is most likely aligned with the travel lane consistent with the direction of travel. The map fusion and arbitration vehicle application 208 may pass map-based location information to the sensor fusion and RWM management vehicle application 212.

The route planning vehicle application 210 may utilize the HD map, as well as inputs from an operator or dispatcher to plan a route to be followed by the vehicle 100 to a particular destination. The route planning vehicle application 210 may pass map-based location information to the sensor fusion and RWM management vehicle application 212. However, the use of a prior map by other vehicle applications, such as the sensor fusion and RWM management vehicle application 212, etc., is not required. For example, other stacks may operate and/or control the vehicle based on perceptual data alone without a provided map, constructing lanes, boundaries, and the notion of a local map as perceptual data is received.

The sensor fusion and RWM management vehicle application 212 may receive data and outputs produced by one or more of the radar perception vehicle application 202, camera perception vehicle application 204, map fusion and arbitration vehicle application 208, and route planning vehicle application 210, and use some or all of such inputs to estimate or refine the location and state of the vehicle 100 in relation to the road, other vehicles on the road, and other objects within a vicinity of the vehicle 100. For example, the sensor fusion and RWM management vehicle application 212 may combine imagery data from the camera perception vehicle application 204 with arbitrated map location information from the map fusion and arbitration vehicle application 208 to refine the determined position of the vehicle within a lane of traffic. As another example, the sensor fusion and RWM management vehicle application 212 may combine object recognition and imagery data from the camera perception vehicle application 204 with object detection and ranging data from the radar perception vehicle application 202 to determine and refine the relative position of other vehicles and objects in the vicinity of the vehicle. As another example, the sensor fusion and RWM management vehicle application 212 may receive information from vehicle-to-vehicle (V2V) communications (such as via the CAN bus) regarding other vehicle positions and directions of travel and combine that information with information from the radar perception vehicle application 202 and the camera perception vehicle application 204 to refine the locations and motions of other vehicles. The sensor fusion and RWM management vehicle application 212 may output refined location and state information of the vehicle 100, as well as refined location and state information of other vehicles and objects in the vicinity of the vehicle, to the motion planning and control vehicle application 214 and/or the behavior planning and prediction vehicle application 216.

As a further example, the sensor fusion and RWM management vehicle application 212 may use dynamic traffic control instructions directing the vehicle 100 to change speed, lane, direction of travel, or other navigational element(s), and combine that information with other received information to determine refined location and state information. The sensor fusion and RWM management vehicle application 212 may output the refined location and state information of the vehicle 100, as well as refined location and state information of other vehicles and objects in the vicinity of the vehicle 100, to the motion planning and control vehicle application 214, the behavior planning and prediction vehicle application 216 and/or devices remote from the vehicle 100, such as a data server, other vehicles, etc., via wireless communications, such as through C-V2X connections, other wireless connections, etc.

As a still further example, the sensor fusion and RWM management vehicle application 212 may monitor perception data from various sensors, such as perception data from a radar perception vehicle application 202, camera perception vehicle application 204, other perception vehicle application, etc., and/or data from one or more sensors themselves to analyze conditions in the vehicle sensor data. The sensor fusion and RWM management vehicle application 212 may be configured to detect conditions in the sensor data, such as sensor measurements being at, above, or below a threshold, certain types of sensor measurements occurring, etc., and may output the sensor data as part of the refined location and state information of the vehicle 100 provided to the behavior planning and prediction vehicle application 216 and/or devices remote from the vehicle 100, such as a data server, other vehicles, etc., via wireless communications, such as through C-V2X connections, other wireless connections, etc.

The refined location and state information may include vehicle descriptors associated with the vehicle 100 and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction vehicle application 216 of the autonomous vehicle system 200 may use the refined location and state information of the vehicle 100 and location and state information of other vehicles and objects output from the sensor fusion and RWM management vehicle application 212 to predict future behaviors of other vehicles and/or objects. For example, the behavioral planning and prediction vehicle application 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction vehicle application 216 may output other vehicle and object behavior and location predictions to the motion planning and control vehicle application 214.

Additionally, the behavior planning and prediction vehicle application 216 may use object behavior in combination with location predictions to plan and generate control signals for controlling the motion of the vehicle 100. For example, based on route planning information, refined location in the roadway information, and relative locations and motions of other vehicles, the behavior planning and prediction vehicle application 216 may determine that the vehicle 100 needs to change lanes and accelerate, such as to maintain or achieve minimum spacing from other vehicles, and/or prepare for a turn or exit. As a result, the behavior planning and prediction vehicle application 216 may calculate or otherwise determine a steering angle for the wheels and a change to the throttle setting to be commanded to the motion planning and control vehicle application 214 and DBW system/control unit 220 along with such various parameters necessary to effectuate such a lane change and acceleration. One such parameter may be a computed steering wheel command angle.

The motion planning and control vehicle application 214 may receive data and information outputs from the sensor fusion and RWM management vehicle application 212 and other vehicle and object behavior as well as location predictions from the behavior planning and prediction vehicle application 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control vehicle application 214 may verify and pass various control commands or instructions to the DBW system/control unit 220.

The DBW system/control unit 220 may receive the commands or instructions from the motion planning and control vehicle application 214 and translate such information into mechanical control signals for controlling wheel angle, brake, and throttle of the vehicle 100. For example, DBW system/control unit 220 may respond to the computed steering wheel command angle by sending corresponding control signals to the steering wheel controller.

In various aspects, the vehicle management system 200 may include functionality that performs safety checks or oversight of various commands, planning or other decisions of various vehicle applications that could impact vehicle and occupant safety. Such safety checks or oversight functionality may be implemented within a dedicated vehicle application or distributed among various vehicle applications and included as part of the functionality. In some aspects, a variety of safety parameters may be stored in memory, and the safety checks or oversight functionality may compare a determined value (e.g., relative spacing to a nearby vehicle, distance from the roadway centerline, etc.) to corresponding safety parameter(s) and may issue a warning or command if the safety parameter is or will be violated. For example, a safety or oversight function in the behavior planning and prediction vehicle application 216 (or in a separate vehicle application) may determine the current or future separate distance between another vehicle (as refined by the sensor fusion and RWM management vehicle application 212) and the vehicle 100 (e.g., based on the world model refined by the sensor fusion and RWM management vehicle application 212), compare that separation distance to a safe separation distance parameter stored in memory, and issue instructions to the motion planning and control vehicle application 214 to speed up, slow down or turn if the current or predicted separation distance violates the safe separation distance parameter. As another example, safety or oversight functionality in the motion planning and control vehicle application 214 (or a separate vehicle application) may compare a determined or commanded steering wheel command angle to a safe wheel angle limit or parameter and may issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of vehicle applications, subsystems, computational elements, or units within a vehicle management system 250, which may be utilized within a vehicle 100. With reference to FIGS. 1A-2B, in some aspects, the vehicle applications 202, 204, 206, 208, 210, 212, and 216 of the vehicle management system 200 may be similar to those described with reference to FIG. 2A and the vehicle management system 250 may operate similar to the vehicle management system 200, except that the vehicle management system 250 may pass various data or instructions to a vehicle safety and crash avoidance system 252 rather than the DBW system/control unit 220. For example, the configuration of the vehicle management system 250 and the vehicle safety and crash avoidance system 252 illustrated in FIG. 2B may be used in a non-autonomous vehicle.

In various aspects, the behavioral planning and prediction vehicle application 216 and/or sensor fusion and RWM management vehicle application 212 may output data to the vehicle safety and crash avoidance system 252. For example, the sensor fusion and RWM management vehicle application 212 may output sensor data as part of refined location and state information of the vehicle 100 provided to the vehicle safety and crash avoidance system 252. The vehicle safety and crash avoidance system 252 may use the refined location and state information of the vehicle 100 to make safety determinations relative to the vehicle 100 and/or occupants of the vehicle 100. As another example, the behavioral planning and prediction vehicle application 216 may output behavior models and/or predictions related to the motion of other vehicles to the vehicle safety and crash avoidance system 252. The vehicle safety and crash avoidance system 252 may use the behavior models and/or predictions related to the motion of other vehicles to make safety determinations relative to the vehicle 100 and/or occupants of the vehicle 100.

In various aspects, the vehicle safety and crash avoidance system 252 may include functionality that performs safety checks or oversight of various commands, planning, or other decisions of various vehicle applications, as well as human driver actions, that could impact vehicle and occupant safety. In some aspects, a variety of safety parameters may be stored in memory and the vehicle safety and crash avoidance system 252 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system 252 may determine the current or future separate distance between another vehicle (as refined by the sensor fusion and RWM management vehicle application 212) and the vehicle (e.g., based on the world model refined by the sensor fusion and RWM management vehicle application 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system 252 may compare a human driver's change in steering wheel angle to a safe wheel angle limit or parameter and may issue an override command and/or alarm in response to the steering wheel angle exceeding the safe wheel angle limit.

Systems that usefully (and in some cases autonomously or semi-autonomously) move through the environment, such as autonomous vehicles or semi-autonomous vehicles, may encounter objects that may not belong to known classes of objects. For example, a vehicle may be trained to classify detected objects into classes of objects to help the vehicle determine how to deal with the detected objects. However, the vehicle may also encounter unusual objects that have fallen into its path, such as branches, rocks, tire treads, etc., or unusual objects with an unusual appearance, such as toppled garbage bins, trucks with unusual cargos, etc. In some cases, a sensor of the vehicle may detect such unusual objects, such as via a camera sensor, radar, and/or LIDAR, but may not be able to reliably identify the unusual object. In such cases, joint tracking and shape estimation may be used to detect and track the unusual object.

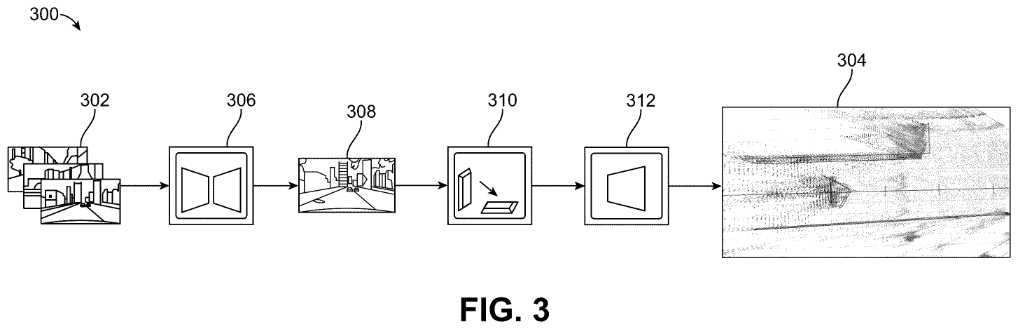

FIG. 3 illustrates an example segmentation process 300, in accordance with aspects of the present disclosure. In some cases, the example segmentation process 300 may be performed as a part of a perception process, such as by perception vehicle application 202, 204 of FIG. 2A/2B. In the example segmentation process 300, input data 302 (e.g., images/frames captured by cameras such as cameras 122, 136 of FIG. 1B, frames captured by sensors, such as LIDAR, radar, etc.) may be processed to generate a segmented bird's eye view (BEV) segmented map 304. The BEV segmented map 304 may include labels and/or bounding boxes/shapes for any objects identified in the frame. The BEV segmented map 304 of the input data 302 may be a representation of the input data 302 from above the scene in the input camera data 302. In the BEV segmented map 304, pixels/features of the frame may be placed on an axis of the representation according to their depth in the frame (e.g., how far away the object represented by pixel is from the vehicle).

As shown in FIG. 3, input data 302 may be input to a camera data encoder 306. In some cases, the input data 302 may include depth information for the pixels of an image being input. This depth information may be obtained using, for example, multiple cameras to capture images and determine depth information, for example using depth from disparity, depth from stereo, or other image-based depth determination techniques. Depth information may also be obtained using a single camera via structure from motion techniques which may match two or more consecutive images from a single camera and determine depth based on disparity as between the images. In some cases, depth information may be obtained from another sensor, such as a depth sensor, depth from stereo, lidar, radar, etc.

The camera data encoder 306 may include one or more feature extractors. The feature extractor(s) of the camera data encoder 306 may be neural network and/or type(s) of machine learning (ML) models and may be used to identify certain features in the camera data. As an example, the feature extractor(s) may include one or more layers or transformer blocks which may include feature maps for recognizing certain features. The camera data encoder 306 may output the identified features as intermediate camera features 308. The input data 302 and camera data encoder 306 may operate in a 2D space (e.g., on a height and width axes with respect to the camera).

A perspective transformation 310 may be applied to the output intermediate camera features. For instance, perspective transformation 310 can be applied to convert the intermediate camera features from, for example, a frontal view of an environment from a vehicle, to BEV projected camera features, as if features were generated based on a camera positioned above the vehicle. In some cases, the perspective transformation 310 may be ML-based (e.g., performed by an ML model, such as a neural network trained to perform the perspective transformation 310). The BEV projected camera features maybe output to a decoder 312. The decoder 312 may include ML models to identify and segment (e.g., label) the BEV projected camera features to generate (e.g., predict) a BEV segmented map 304. In some cases, the perspective transformation 310 may be skipped. For example, where depth information is available (e.g., via depth sensor, depth from stereo, lidar, radar, etc.), the perspective transformation 310 may be skipped and the intermediate camera features 308 may be passed to the decoder 312.

In some cases, during a segmentation process, frames may be examined to identify objects present within the frames. Objects in an frame may be identified by using one or more neural networks, such as a convolutional neural network (CNN), or other ML models to assign segmentation classes (e.g., person, class, car class, background class, etc.) to each feature/pixel (e.g., points) in a frame and then grouping contiguous points sharing a segmentation class to form an object of the segmentation class (e.g., a person, car, background, etc.). This technique may be referred to as semantic segmentation. For semantic segmentation, one segmentation class may include a road class, which may identify points associated with a road the vehicle is on. Identifying points associated with the road class allows the segmentation process to distinguish road points from non-road points, which may be used to detect objects that appear on the road (e.g., deviates from an area of road points). In some cases, one or more ML models may be trained to identify instances of objects or elements related to certain objects, such as a space under a vehicle. This technique may be referred to as instance segmentation. Other segmentation processes may also be used. In some cases, the segmentation process may output sets of three dimensional (3D) points, such as shown in the BEV segmented map 304. In some cases, these 3D points may be grouped and represented for further processing.

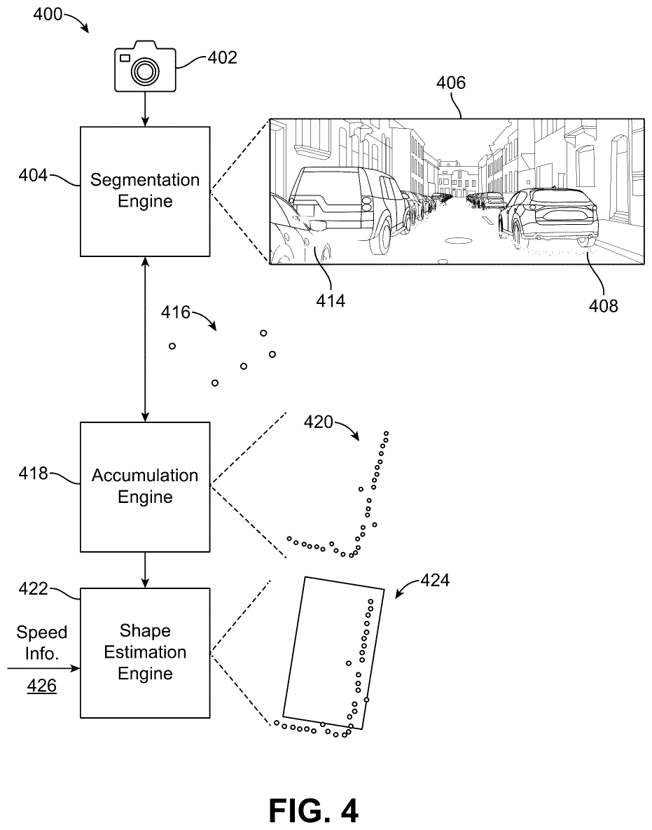

FIG. 4 illustrates an example joint tracking and shape estimation technique 400, in accordance with aspects of the present disclosure. In some cases, the joint tracking and shape estimation technique 400 may be performed as a part of a perception process, such as by perception vehicle application 202, 204 of FIG. 2A and/or FIG. 2B. In FIG. 4, frame data 406 may be obtained from one or more sensors 402 (e.g., camera(s), radar, LIDAR, etc.) by a segmentation engine 404. The segmentation engine 404 may perform a segmentation process to label points in the frame data 406.

In this example, the segmentation engine 404 may perform instance segmentation and may attempt to identify areas of the frame which correspond to areas underneath vehicles, such as area 408. For identified areas, the segmentation engine 404 may output a segmentation mask, or map, of the input frame labeling the object to a tracking engine 412 to track the identified object. In some cases, the segmentation engine 404 may also determine a distance to the labelled object. The distance to the labelled object may be a distance between the ego vehicle (or sensor of the ego vehicle) and the labelled object.

The segmentation engine 404 may output an indication of the detected one or more points 416 (e.g., via a segmentation mask, set of points, etc.), along with distance information for points of the one more points, to an accumulation engine 418. Here, the distance to the points may be a distance between the ego vehicle (or sensor of the ego vehicle, such as a camera, LIDAR sensor, radar sensor, etc.) and a specific point. The detected one or more points 416 may be passed to the accumulation engine 418. In some cases, the detected points may be passed as a 3D points (e.g., with depth information).

In some cases, additional points may be gathered from additional frames and these additional points may be used to help resolve the object. For example, additional points may be detected in future frames and these additional points may be accumulated (e.g., combined) with the detected one or more points 416. Accumulating the detected points may help provide additional information that may not be detectable in a single frame (e.g., image). To accumulate the points, the segmentation engine 404 may pass the detected points in additional frames to the accumulation engine 418. In some cases, the accumulation of points may be performed separately from state estimation (e.g., estimating position and/or motion) of the object.

The accumulation engine 418 may accumulate points (e.g., feature points, features, etc.) 420 received from the segmentation engine 404 over a number of frames. In some cases, the accumulation engine 418 may accumulate points by stacking the points from the segmentation engine 404 for a configurable number of frames (e.g., images) or until a configurable number of points have been accumulated. In some cases, the number of points may be variable based on the distance to the points. In some cases, accumulated points may be removed by the accumulation engine 418 over time. For example, points may be removed after a predetermined number of frames (and/or a predetermined amount of time), from the accumulated points to help keep the accumulated points relevant. The predetermined number of frames (e.g., time) after which a point may be removed may be configurable. After accumulating features for the number of frames, the accumulation engine 418 may pass the accumulated points 420 to a shape estimation engine 422.

The shape estimation engine 422 may attempt to estimate a shape 424 of the object associated with the accumulated points 420. In some cases, the segmentation process may classify points in such a way that multiple points may be associated. For example, multiple nearby points with the same segmentation class may be associated. In some cases, multiple instances of a single segmentation class may also be indicated. In some examples, points in an unknown or a non-road segmentation class that deviates from surrounding points with a road segmentation class may be associated. In some cases, the shape estimation engine 422 may attempt to estimate the shape 424 of an object based on a set of associated points. For example, the shape estimation engine may use a best fit or clustering algorithm to estimate the shape.

In some cases, the shape estimation engine 422 may attempt to use a velocity of the features to help estimate the shape 424 of the object. For example, as indicated above, a set of points may be associated, for example, based on segmentation classes and observed over a number of frames (e.g., images) to accumulate points. In some cases, the shape estimation engine 432 may also receive speed information 426 about a speed an ego vehicle (e.g., vehicle performing the joint tracking and shape estimation technique 400) is travelling. In some cases, a Kalman filter may be used to predict/compensate for potential motion of the ego vehicle and the object. Based on location differences (e.g., distance from the ego vehicle) of the points of the set of points from frame to frame and the speed information 426, the shape estimation engine 432 may estimate a velocity vector for the set of points. The velocity vector may include a speed the set of points are moving along with a direction the set of points are moving. In some cases, the velocity vector may be obtained based on a state vector which may be used to estimate a position and/or motion of the object separate from the shape estimation. If the velocity vector indicates that the object associated with the set of points is moving at a relatively high speed (e.g., 5 m/s, 7 m/s, etc.), it may be assumed that the object is a vehicle and a rectangular shape may be used for shape estimation and that the rectangular shape may be aligned with the velocity vector. In some cases, a determination that the set of points is moving at a relatively high speed may be based on a velocity threshold. The rectangular shape may then be sized and placed such that the rectangular shape overlaps (e.g., fits) as many points of the set of points as possible. The resulting shape may be determined as the estimated shape. The estimated shape may be output for further processing, such as for tracking, by the device.

In some cases, if the velocity vector indicates that the object associated with the set of points is not moving, or has a relatively low velocity vector, then the velocity vector may not be a reliable indicator for the object. In some cases, a more general shape, such as a polygon may be used. This polygon may be fitted based on the outermost points of the set of points such that the polygon surrounds the set of points.

In some cases, outlier removal may be performed. For a set of points, points which are statically further away from neighboring points may be removed. For example, the top 5% of points that are the furthest from a neighboring point may be removed. The number of points, of the set of points, that may be removed may be configurable.

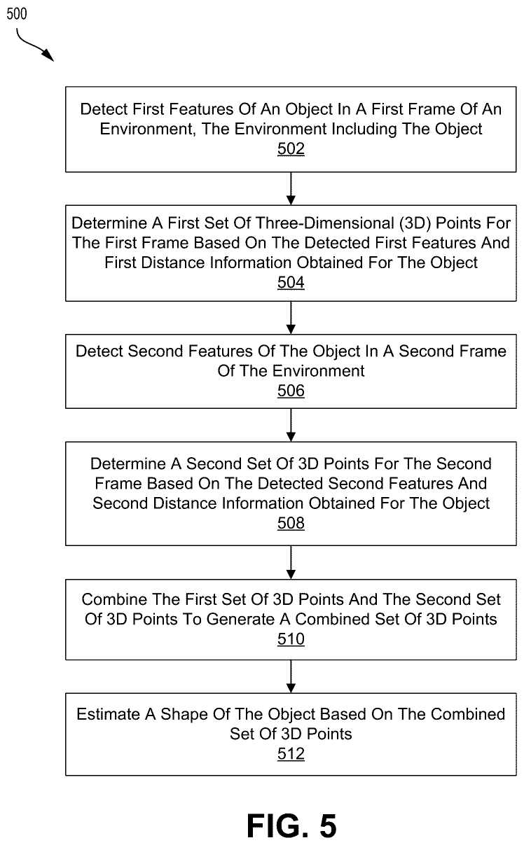

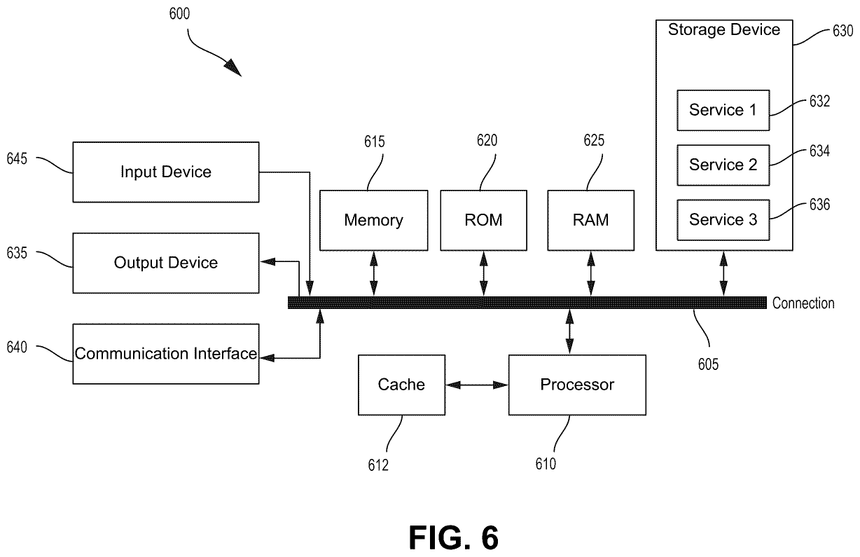

FIG. 5 is a flow diagram illustrating a process 500 for object detection, in accordance with aspects of the present disclosure. The process 500 may be performed by a computing device (or apparatus, e.g., vehicle 100 of FIG. 1A-1B, SOC 105 of FIG. 1D, vehicle management system 200 of FIG. 2A-2B, computing system 600 of FIG. 6, etc.) or a component (e.g., a chipset, codec, vehicle control unit 140 of FIG. 1A-1B, processor 164 of FIG. 1C, CPU 110, GPU 115, DSP 106, NPU 125 of FIG. 1D, processor 610 of FIG. 6, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 500 may be implemented as software components that are executed and run on one or more processors.

At block 502, the computing device (or component thereof) may detect first features of an object (e.g., another vehicle, trees, signs, etc.) in a first frame (e.g., frame data 406 of FIG. 4) of an environment, the environment including the object.

At block 504, the computing device (or component thereof) may determine a first set of three-dimensional (3D) points (e.g., one or more points 416 of FIG. 4) for the first frame based on the detected first features and first distance information obtained for the object.

At block 506, the computing device (or component thereof) may detect second features of the object in a second frame of the environment.

At block 508, the computing device (or component thereof) may determine a second set of 3D points for the second frame based on the detected second features and second distance information obtained for the object. In some cases, the computing device (or component thereof) may determine a velocity of the object based on the first set of 3D points and the second set of 3D points. In some examples, the shape of the object is estimated based on the velocity of the object. In some cases, the computing device (or component thereof) may determine that the velocity of the object is above a threshold velocity; and determine that the shape of the object is rectangular based on the velocity being above the threshold velocity. In some examples, the velocity of the object is included in a velocity vector, the velocity vector further including a direction the object is moving. In some cases, the computing device (or component thereof) may align a rectangular shape (e.g., shape 424 of FIG. 4) based on the direction the object is moving. In some examples, values of the velocity vector are determined independent of a state vector. In some cases, the computing device (or component thereof) may determine that the velocity of the object is below a threshold velocity; and determine the shape of the object by fitting a polygon around the first set of 3D points and the second set of 3D points. In some examples, the first distance comprises a first distance from the apparatus to the object and the second distance comprises a second distance from the apparatus to the object.

At block 510, the computing device (or component thereof) may combine (e.g., by an accumulation 418 of FIG. 4) the first set of 3D points and the second set of 3D points to generate a combined set of 3D points (e.g., points 420 of FIG. 4). In some cases, 3D points for the object are combined for a predetermined number of frames to perform shape estimation of the object. In some examples, 3D points for the object are combined for a predetermined number of 3D points to perform shape estimation of the object. In some cases, the computing device (or component thereof) may determine a set of outlier 3D points of the first set of 3D points and the second set of 3D points based on a distance between an outlier 3D point and a neighboring point; and remove the set of outlier 3D points.

At block 512, the computing device (or component thereof) may estimate a shape (e.g., shape 424 of FIG. 4) of the object based on the combined set of 3D points.

In some examples, the processes described herein (e.g., process 500 and/or other process described herein) may be performed by the vehicle 100 of FIG. 1A.

In some cases, the devices or apparatuses configured to perform the operations of the process 500 and/or other processes described herein may include a processor, microprocessor, micro-computer, or other component of a device that is configured to carry out the steps of the process 500 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus re-ceives the sensed data. Such device or apparatus may further include a network interface con-figured to communicate data.

The components of the device or apparatus configured to carry out one or more operations of the process 500 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), cen-tral processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network inter-face configured to communicate and/or receive the data, any combination thereof, and/or other component(s). The network interface may be configured to communicate and/or receive Inter-net Protocol (IP) based data or other type of data.

The process 500 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some embodiments, computing system 600 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some embodiments, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for shape estimation, comprising: at least one memory; and at least one processor coupled to the at least one memory and configured to: detect first features of an object in a first frame of an environment, the environment including the object; determine a first set of three-dimensional (3D) points for the first frame based on the detected first features and first distance information obtained for the object; detect second features of the object in a second frame of the environment; determine a second set of 3D points for the second frame based on the detected second features and second distance information obtained for the object; combine the first set of 3D points and the second set of 3D points to generate a combined set of 3D points; and estimate a shape of the object based on the combined set of 3D points.

Aspect 2. The apparatus of Aspect 1, wherein 3D points for the object are combined for a predetermined number of frames to perform shape estimation of the object.

Aspect 3. The apparatus of any of Aspects 1-2, wherein 3D points for the object are combined for a predetermined number of 3D points to perform shape estimation of the object.

Aspect 4. The apparatus of any of Aspects 1-3, wherein the at least one processor is further configured to determine a velocity of the object based on the first set of 3D points and the second set of 3D points.

Aspect 5. The apparatus of Aspect 4, wherein the shape of the object is estimated based on the velocity of the object.

Aspect 6. The apparatus of Aspect 5, wherein the at least one processor is further configured to: determine that the velocity of the object is above a threshold velocity; and determine that the shape of the object is rectangular based on the velocity being above the threshold velocity.

Aspect 7. The apparatus of Aspect 6, wherein the velocity of the object is included in a velocity vector, the velocity vector further including a direction the object is moving, and wherein the at least one processor is further configured to align a rectangular shape based on the direction the object is moving.

Aspect 8. The apparatus of Aspect 7, wherein values of the velocity vector are determined independent of a state vector.

Aspect 9. The apparatus of any of Aspects 5-8, wherein the at least one processor is further configured to: determine that the velocity of the object is below a threshold velocity; and determine the shape of the object by fitting a polygon around the first set of 3D points and the second set of 3D points.

Aspect 10. The apparatus of any of Aspects 1-9, wherein the at least one processor is further configured to: determine a set of outlier 3D points of the first set of 3D points and the second set of 3D points based on a distance between an outlier 3D point and a neighboring point; and remove the set of outlier 3D points.

Aspect 11. The apparatus of any of Aspects 1-10, wherein the first distance comprises a first distance from the apparatus to the object and the second distance comprises a second distance from the apparatus to the object.

Aspect 12. A method for shape estimation, comprising: detecting first features of an object in a first frame of an environment, the environment including the object; determining a first set of three-dimensional (3D) points for the first frame based on the detected first features and first distance information obtained for the object; detecting second features of the object in a second frame of the environment; determining a second set of 3D points for the second frame based on the detected second features and second distance information obtained for the object; combining the first set of 3D points and the second set of 3D points to generate a combined set of 3D points; and estimating a shape of the object based on the combined set of 3D points.

Aspect 13. The method of Aspect 12, wherein 3D points for the object are combined for a predetermined number of frames to perform shape estimation of the object.

Aspect 14. The method of any of Aspects 12-13, wherein 3D points for the object are combined for a predetermined number of 3D points to perform shape estimation of the object.

Aspect 15. The method of any of Aspects 12-14, further comprising determining a velocity of the object based on the first set of 3D points and the second set of 3D points.

Aspect 16. The method of Aspect 15, wherein the shape of the object is estimated based on the velocity of the object.

Aspect 17. The method of Aspect 16, further comprising: determining that the velocity of the object is above a threshold velocity; and determining that the shape of the object is rectangular based on the velocity being above the threshold velocity.

Aspect 18. The method of Aspect 17, wherein the velocity of the object is included in a velocity vector, the velocity vector further including a direction the object is moving, and further comprising aligning a rectangular shape based on the direction the object is moving.

Aspect 19. The method of Aspect 18, wherein values of the velocity vector are determined independent of a state vector.

Aspect 20. The method of any of Aspects 16-19, further comprising: determining that the velocity of the object is below a threshold velocity; and determining the shape of the object by fitting a polygon around the first set of 3D points and the second set of 3D points.

Aspect 21. The method of any of Aspects 12-20, further comprising: determining a set of outlier 3D points of the first set of 3D points and the second set of 3D points based on a distance between an outlier 3D point and a neighboring point; and removing the set of outlier 3D points.

Aspect 22. The method of any of Aspects 12-21, wherein the first distance comprises a first distance from an apparatus to the object and the second distance comprises a second distance from the apparatus to the object.

Aspect 23. A non-transitory computer-readable medium having stored thereon instructions that, when executed by at least one processor, cause the at least one processor to: detect first features of an object in a first frame of an environment, the environment including the object; determine a first set of three-dimensional (3D) points for the first frame based on the detected first features and first distance information obtained for the object; detect second features of the object in a second frame of the environment; determine a second set of 3D points for the second frame based on the detected second features and second distance information obtained for the object; combine the first set of 3D points and the second set of 3D points to generate a combined set of 3D points; and estimate a shape of the object based on the combined set of 3D points.

Aspect 24. The non-transitory computer-readable medium of Aspect 23, wherein 3D points for the object are combined for a predetermined number of frames to perform shape estimation of the object.

Aspect 25. The non-transitory computer-readable medium of any of Aspects 23-24, wherein 3D points for the object are combined for a predetermined number of 3D points to perform shape estimation of the object.

Aspect 26. The non-transitory computer-readable medium of any of Aspects 23-25, wherein the instructions cause the at least one processor to determine a velocity of the object based on the first set of 3D points and the second set of 3D points.

Aspect 27. The non-transitory computer-readable medium of Aspect 26, wherein the shape of the object is estimated based on the velocity of the object.

Aspect 28. The non-transitory computer-readable medium of Aspect 27, wherein the instructions cause the at least one processor to: determine that the velocity of the object is above a threshold velocity; and determine that the shape of the object is rectangular based on the velocity being above the threshold velocity.

Aspect 29. The non-transitory computer-readable medium of Aspect 28, wherein the velocity of the object is included in a velocity vector, the velocity vector further including a direction the object is moving, and wherein the instructions cause the at least one processor to align a rectangular shape based on the direction the object is moving.

Aspect 30. The non-transitory computer-readable medium of Aspect 29, wherein values of the velocity vector are determined independent of a state vector.

Aspect 31. The non-transitory computer-readable medium of any of Aspects 27-30, wherein the instructions cause the at least one processor to: determine that the velocity of the object is below a threshold velocity; and determine the shape of the object by fitting a polygon around the first set of 3D points and the second set of 3D points.

Aspect 32. The non-transitory computer-readable medium of any of Aspects 23-31, wherein the instructions cause the at least one processor: determine a set of outlier 3D points of the first set of 3D points and the second set of 3D points based on a distance between an outlier 3D point and a neighboring point; and remove the set of outlier 3D points.

Aspect 33. The non-transitory computer-readable medium of any of Aspects 23-3, wherein the first distance comprises a first distance from the apparatus to the object and the second distance comprises a second distance from the apparatus to the object.

Aspect 34. An apparatus for shape estimation comprising one or more means for performing operations according to any of Aspects 12-22.

What is claimed is:

1. An apparatus for shape estimation, comprising:
at least one memory; and
at least one processor coupled to the at least one memory and configured to:
detect first features of an object in a first frame of an environment, the environment including the object;
determine a first set of three-dimensional (3D) points for the first frame based on the detected first features and first distance information obtained for the object;
detect second features of the object in a second frame of the environment;
determine a second set of 3D points for the second frame based on the detected second features and second distance information obtained for the object;
combine the first set of 3D points and the second set of 3D points to generate a combined set of 3D points; and
estimate a shape of the object based on the combined set of 3D points.

2. The apparatus of claim 1, wherein 3D points for the object are combined for a predetermined number of frames to perform shape estimation of the object.

3. The apparatus of claim 1, wherein 3D points for the object are combined for a predetermined number of 3D points to perform shape estimation of the object.

4. The apparatus of claim 1, wherein the at least one processor is further configured to determine a velocity of the object based on the first set of 3D points and the second set of 3D points.

5. The apparatus of claim 4, wherein the shape of the object is estimated based on the velocity of the object.

6. The apparatus of claim 5, wherein the at least one processor is further configured to:
determine that the velocity of the object is above a threshold velocity; and
determine that the shape of the object is rectangular based on the velocity being above the threshold velocity.

7. The apparatus of claim 6, wherein the velocity of the object is included in a velocity vector, the velocity vector further including a direction the object is moving, and wherein the at least one processor is further configured to align a rectangular shape based on the direction the object is moving.

8. The apparatus of claim 7, wherein values of the velocity vector are determined independent of a state vector.

9. The apparatus of claim 5, wherein the at least one processor is further configured to:
determine that the velocity of the object is below a threshold velocity; and
determine the shape of the object by fitting a polygon around the first set of 3D points and the second set of 3D points.

10. The apparatus of claim 1, wherein the at least one processor is further configured to:
determine a set of outlier 3D points of the first set of 3D points and the second set of 3D points based on a distance between an outlier 3D point and a neighboring point; and
remove the set of outlier 3D points.

11. The apparatus of claim 1, wherein the first distance comprises a first distance from the apparatus to the object and the second distance comprises a second distance from the apparatus to the object.

12. A method for shape estimation, comprising:
detecting first features of an object in a first frame of an environment, the environment including the object;
determining a first set of three-dimensional (3D) points for the first frame based on the detected first features and first distance information obtained for the object;
detecting second features of the object in a second frame of the environment;
determining a second set of 3D points for the second frame based on the detected second features and second distance information obtained for the object;
combining the first set of 3D points and the second set of 3D points to generate a combined set of 3D points; and
estimating a shape of the object based on the combined set of 3D points.

13. The method of claim 12, wherein 3D points for the object are combined for a predetermined number of frames to perform shape estimation of the object.

14. The method of claim 12, wherein 3D points for the object are combined for a predetermined number of 3D points to perform shape estimation of the object.

15. The method of claim 12, further comprising determining a velocity of the object based on the first set of 3D points and the second set of 3D points.

16. The method of claim 15, wherein the shape of the object is estimated based on the velocity of the object.

17. The method of claim 16, further comprising:
determining that the velocity of the object is above a threshold velocity; and
determining that the shape of the object is rectangular based on the velocity being above the threshold velocity.

18. The method of claim 17, wherein the velocity of the object is included in a velocity vector, the velocity vector further including a direction the object is moving, and further comprising aligning a rectangular shape based on the direction the object is moving.

19. The method of claim 18, wherein values of the velocity vector are determined independent of a state vector.

20. The method of claim 16, further comprising:
determining that the velocity of the object is below a threshold velocity; and
determining the shape of the object by fitting a polygon around the first set of 3D points and the second set of 3D points.

21. The method of claim 12, further comprising:
determining a set of outlier 3D points of the first set of 3D points and the second set of 3D points based on a distance between an outlier 3D point and a neighboring point; and
removing the set of outlier 3D points.

22. The method of claim 12, wherein the first distance comprises a first distance from an apparatus to the object and the second distance comprises a second distance from the apparatus to the object.

23. A non-transitory computer-readable medium having stored thereon instructions that, when executed by at least one processor, cause the at least one processor to:
detect first features of an object in a first frame of an environment, the environment including the object;
determine a first set of three-dimensional (3D) points for the first frame based on the detected first features and first distance information obtained for the object;
detect second features of the object in a second frame of the environment;
determine a second set of 3D points for the second frame based on the detected second features and second distance information obtained for the object;
combine the first set of 3D points and the second set of 3D points to generate a combined set of 3D points; and
estimate a shape of the object based on the combined set of 3D points.

24. The non-transitory computer-readable medium of claim 23, wherein 3D points for the object are combined for a predetermined number of frames to perform shape estimation of the object.

25. The non-transitory computer-readable medium of claim 23, wherein 3D points for the object are combined for a predetermined number of 3D points to perform shape estimation of the object.

26. The non-transitory computer-readable medium of claim 23, wherein the instructions cause the at least one processor to determine a velocity of the object based on the first set of 3D points and the second set of 3D points.

27. The non-transitory computer-readable medium of claim 26, wherein the shape of the object is estimated based on the velocity of the object.

28. The non-transitory computer-readable medium of claim 27, wherein the instructions cause the at least one processor to:
determine that the velocity of the object is above a threshold velocity; and
determine that the shape of the object is rectangular based on the velocity being above the threshold velocity.

29. The non-transitory computer-readable medium of claim 28, wherein the velocity of the object is included in a velocity vector, the velocity vector further including a direction the object is moving, and wherein the instructions cause the at least one processor to align a rectangular shape based on the direction the object is moving.

30. The non-transitory computer-readable medium of claim 29, wherein values of the velocity vector are determined independent of a state vector.
